(19) United States
(12) Patent Application Publication
(10) Pub. No.: US 2026/0025808 A1
(43) Pub. Date: Jan. 22, 2026

(54) COMMUNICATION METHOD AND COMMUNICATION APPARATUS

(71) Applicant: GUANGDONG OPPO MOBILE TELECOMMUNICATIONS CORP., LTD., Dongguan (CN)

(72) Inventors: Teng MA, Dongguan (CN); Zhenshan ZHAO, Dongguan (CN); Shichang ZHANG, Dongguan (CN)

(73) Assignee: GUANGDONG OPPO MOBILE TELECOMMUNICATIONS CORP., LTD., Dongguan (CN)

(21) Appl. No.: 19/343,879

(22) Filed: Sep. 29, 2025

Related U.S. Application Data
(63) Continuation of application No. PCT/CN2023/084806, filed on Mar. 29, 2023.

(51) Int. Cl. H04W 72/0453; H04W 92/18

(52) U.S. Cl. CPC H04W 72/0453; H04W 92/18

(57) ABSTRACT

Provided are a communication method and a communication apparatus. The method comprises: a first terminal device performing sidelink communication with a second terminal device by means of a first frequency domain bandwidth or a first resource pool, wherein the first terminal device is configured with the first frequency domain bandwidth and/or a second frequency domain bandwidth for a sidelink, or the first resource pool and/or the second frequency domain bandwidth for the sidelink, the second terminal device is configured with a third frequency domain bandwidth for the sidelink, and the first frequency domain bandwidth or the bandwidth of the first resource pool is less than or equal to the third frequency domain bandwidth.

### CROSS-REFERENCE TO RELATED APPLICATIONS

This application is a continuation of International Application No. PCT/CN2023/084806, filed on Mar. 29, 2023, the disclosure of which is hereby incorporated by reference in its entirety.

### TECHNICAL FIELD

This application relates to the field of communication technologies, and more specifically, to a communication method and a communication apparatus.

### BACKGROUND

With development of communication technologies, terminal devices with different capabilities may be supported in some communication systems. However, it is not clear how terminal devices with different capabilities communicate with each other on a sidelink (SL).

### SUMMARY

Embodiments of this application provide a communication method and a communication apparatus. The following describes various aspects involved in embodiments of this application.

According to a first aspect, a communication method is provided, including: performing, by a first terminal device, sidelink communication with a second terminal device by using a first frequency domain bandwidth or a first resource pool, where the first terminal device is configured with the first frequency domain bandwidth and/or a second frequency domain bandwidth used for sidelink, or configured with the first resource pool and/or a second frequency domain bandwidth used for sidelink, the second terminal device is configured with a third frequency domain bandwidth used for sidelink, and the first frequency domain bandwidth or a bandwidth of the first resource pool is less than or equal to the third frequency domain bandwidth.

According to a second aspect, a communication method is provided, including: transmitting and/or receiving, by a first terminal device, a system message over a sidelink by using a first frequency domain bandwidth, where the first terminal device is configured with the first frequency domain bandwidth and a second frequency domain bandwidth used for sidelink, and the first frequency domain bandwidth is a part of the second frequency domain bandwidth.

According to a third aspect, a communication apparatus is provided, including a communication unit, configured to perform sidelink communication with a second terminal device by using a first frequency domain bandwidth or a first resource pool, where the apparatus is configured with the first frequency domain bandwidth and/or a second frequency domain bandwidth used for sidelink, or configured with the first resource pool and/or a second frequency domain bandwidth used for sidelink, the second terminal device is configured with a third frequency domain bandwidth used for sidelink, and the first frequency domain bandwidth or a bandwidth of the first resource pool is less than or equal to the third frequency domain bandwidth.

According to a fourth aspect, a communication apparatus is provided, including a communication unit, configured to transmit and/or receive a system message over a sidelink by using a first frequency domain bandwidth, where the apparatus is configured with the first frequency domain bandwidth and a second frequency domain bandwidth used for sidelink, and the first frequency domain bandwidth is a part of the second frequency domain bandwidth.

According to a fifth aspect, there is provided a communication apparatus. The communication apparatus includes a memory, a transceiver, and a processor, where the memory is configured to store a program, the processor performs data transmission and reception by using the transceiver, and the processor is configured to invoke the program in the memory to cause the communication apparatus to execute the method according to the first aspect.

According to a sixth aspect, there is provided a communication apparatus. The communication apparatus includes a memory, a transceiver, and a processor, where the memory is configured to store a program, the processor performs data transmission and reception by using the transceiver, and the processor is configured to invoke the program in the memory to cause the communication apparatus to execute the method according to the second aspect.

According to a seventh aspect, there is provided a communication apparatus. The communication apparatus includes a processor configured to invoke a program from a memory to cause the communication apparatus to execute the method according to the first aspect.

According to an eighth aspect, there is provided a communication apparatus. The communication apparatus includes a processor configured to invoke a program from a memory to cause the communication apparatus to execute the method according to the second aspect.

According to a ninth aspect, a chip is provided, including a processor, configured to invoke a program from a memory, to cause a device installed with the chip to execute the method according to the first aspect.

According to a tenth aspect, a chip is provided, including a processor, configured to invoke a program from a memory, to cause a device installed with the chip to execute the method according to the second aspect.

According to an eleventh aspect, a computer-readable storage medium is provided, where a program is stored on the computer-readable storage medium, and the program causes a computer to execute the method according to the first aspect.

According to a twelfth aspect, a computer-readable storage medium is provided, where a program is stored on the computer-readable storage medium, and the program causes a computer to execute the method according to the second aspect.

According to a thirteenth aspect, a computer program product is provided, including a program, where the program causes a computer to execute the method according to the first aspect.

According to a fourteenth aspect, a computer program product is provided, including a program, where the program causes a computer to execute the method according to the second aspect.

According to a fifteenth aspect, a computer program is provided, where the computer program causes a computer to execute the method according to the first aspect.

According to a sixteenth aspect, a computer program is provided, where the computer program causes a computer to execute the method according to the second aspect.

### BRIEF DESCRIPTION OF DRAWINGS

FIG. 1 is an example diagram of a wireless communication system to which an embodiment of this application is applied.

FIG. 2 is an example diagram of a wireless communication system to which another embodiment of this application is applied.

FIG. 3 is an example diagram of a wireless communication system to which still another embodiment of this application is applied.

FIG. 4 is an example diagram of a wireless communication system to which still another embodiment of this application is applied.

FIG. 5 is an example diagram of unicast transmission according to an embodiment of this application.

FIG. 6 is an example diagram of multicast transmission according to an embodiment of this application.

FIG. 7 is an example diagram of broadcast transmission according to an embodiment of this application.

FIG. 8 is an example diagram of a slot structure in V2X according to an embodiment of this application.

FIG. 9 is a schematic diagram of a PSFCH resource in a slot and a corresponding number of OFDM symbols.

FIG. 10 is a schematic diagram of a 2nd-stage SCI mapping manner.

FIG. 11 is a schematic diagram of a time-frequency domain location of a DMRS in a PSCCH.

FIG. 12 is a schematic diagram of time domain locations of four DMRS symbols when there are 13 symbols in a PSSCH.

FIG. 13 is a schematic diagram of a single-symbol DMRS frequency domain type 1.

FIG. 14 is a schematic diagram of a time-frequency location of an SL CSI-RS.

FIG. 15 is a schematic diagram of channel occupancy time and channel occupancy.

FIG. 16 is a schematic flowchart of a communication method according to an embodiment of this application.

FIG. 17 is a schematic diagram of a first frequency domain bandwidth according to an embodiment of this application.

FIG. 18 is a schematic diagram of a first frequency domain bandwidth according to another embodiment of this application.

FIG. 19 is a schematic diagram of a first resource pool according to an embodiment of this application.

FIG. 20 is a schematic flowchart of a communication method according to an embodiment of this application.

FIG. 21 is a schematic diagram of a first frequency domain bandwidth according to another embodiment of this application.

FIG. 22 is a schematic structural diagram of a communication apparatus according to an embodiment of this application.

FIG. 23 is a schematic structural diagram of a communication apparatus according to another embodiment of this application.

FIG. 24 is a schematic structural diagram of an apparatus according to an embodiment of this application.

### DESCRIPTION OF EMBODIMENTS

Technical solutions in this application are described below with reference to the accompanying drawings.

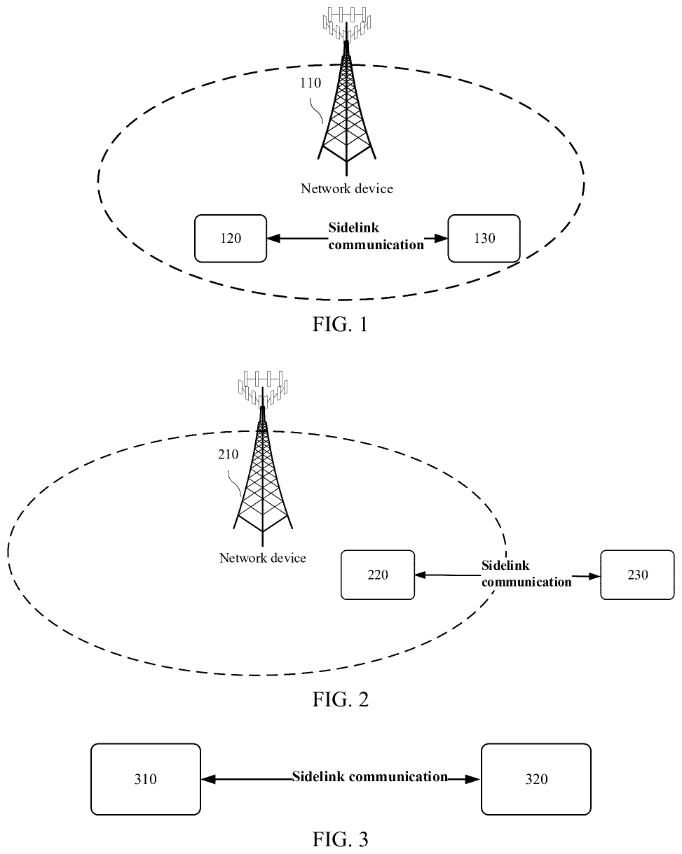

FIG. 1 shows a wireless communication system 100 to which embodiments of this application are applied. The wireless communication system 100 may include a network device 110 and user equipment (UE) 120. The network device 110 may communicate with UE 120. The network device 110 may provide communication coverage for a specific geographic area, and may communicate with UE 120 within the coverage. UE 120 may access a network (for example, a wireless network) by using the network device 110.

FIG. 1 shows one network device and two UEs as an example. Optionally, the wireless communication system 100 may include a plurality of network devices, and another number of terminal devices may be included within coverage of each network device, which is not limited in embodiments of this application. Optionally, the wireless communication system 100 may further include another network entity such as a network controller or a mobility management entity, which is not limited in embodiments of this application.

It should be understood that the technical solutions of embodiments of this application may be applied to various communication systems, such as a 5th generation (5G) system or a new radio (NR) system, a long-term evolution (LTE) system, an LTE frequency division duplex (FDD) system, and an LTE time division duplex (TDD) system. The technical solutions provided in this application may further be applied to a future communication system, such as a 6th generation mobile communication system or a satellite communication system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communication device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device for communicating with the UE. The network device may also be referred to as an access network device or a radio access network device. For example, the network device may be a base station. The network device in embodiments of this application may be a radio access network (RAN) node (or device) that connects the UE to a wireless network. The base station may broadly cover devices having the following various names, or may be interchanged with the devices having following names, such as a NodeB, an evolved NodeB (eNB), a next generation NodeB (gNB), a relay station, an access point, a transmitting and receiving point (TRP), a transmitting point (TP), a master eNode MeNB, a secondary eNode SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof.

In some embodiments, the network device may be a fixed or mobile network device. For example, a helicopter or an unmanned aerial vehicle may be configured to function as a mobile network device, and one or more cells may move depending on a location of the mobile network device. In other examples, a helicopter or an unmanned aerial vehicle may be configured to function as a device that communicates with another network device. In some embodiments, the network device may be a CU or a DU, or the network device may include a CU and a DU, or the network device may further include an AAU.

It should be understood that the network device may be deployed on land, including being indoors or outdoors, handheld, or vehicle-mounted, may be deployed on a water surface, or may be deployed on a plane, a balloon, or a satellite in the air. In embodiments of this application, the network device and a scenario in which the network device is located in embodiments of this application are not limited.

It should also be understood that all or some of functions of the network device and the UE in this application may also be implemented by software functions running on hardware, or by virtualization functions instantiated on a platform (for example, a cloud platform).

The technical solutions in embodiments of this application may be applied to sidelink communication (namely, communication over a sidelink). The following first describes the sidelink communication in detail.

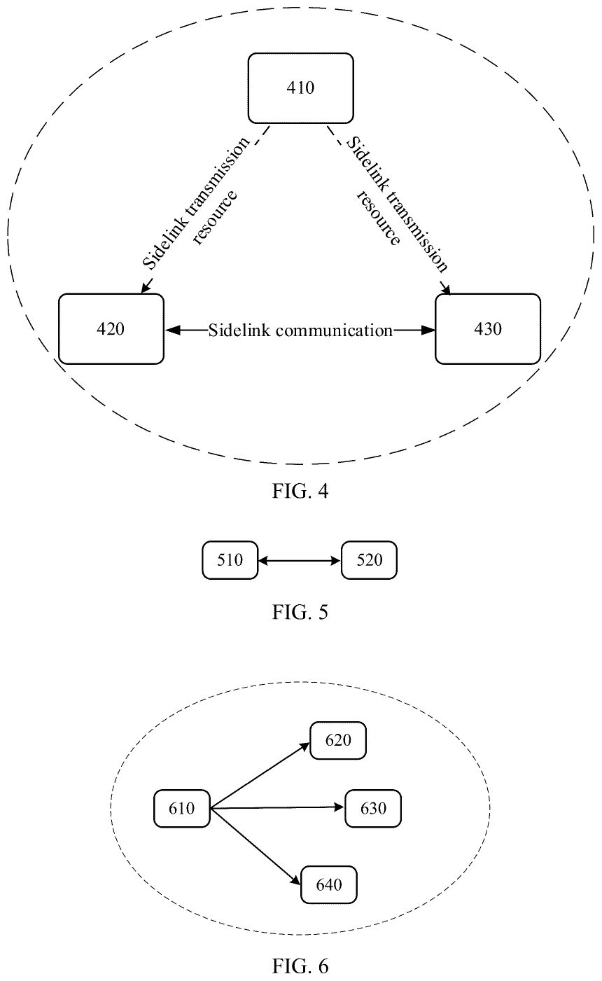

Sidelink communication may be classified, depending on different network coverage statuses of a terminal device that performs communication, into sidelink communication within network coverage, sidelink communication with partial network coverage, and sidelink communication outside network coverage, specifically as shown in FIG. 1, FIG. 2, FIG. 3, and FIG. 4.

In the sidelink communication within network coverage, all terminal devices that perform sidelink communication are within coverage of a same base station. As shown in FIG. 1, both terminal devices 120 and 130 are within network coverage of a network device 110, and can receive a sidelink configuration transmitted by the network device 110, and perform sidelink communication based on the sidelink configuration.

In the case of the sidelink communication with partial network coverage, some terminal devices performing sidelink communication are located within coverage of a network device. As shown in FIG. 2, a terminal device 220 can receive a sidelink configuration from a network device 210 and perform sidelink communication based on the sidelink configuration. However, a terminal device 230 located outside network coverage cannot receive a sidelink configuration from the network device 210. In this case, the terminal device 230 outside the network coverage can determine the sidelink configuration based on pre-configuration information and information carried in a physical sidelink broadcast channel (PSBCH) sent by the terminal device 220, and perform sidelink communication based on the sidelink configuration.

For the sidelink communication outside network coverage, all terminal devices that perform sidelink communication are located outside the network coverage. As shown in FIG. 3, both terminal devices 310 and 320 are located outside network coverage. In this case, the terminal devices 310 and 320 may each determine a sidelink configuration based on pre-configuration information, and may perform sidelink communication based on the sidelink configuration.

In sidelink communication, a plurality of terminal devices may further form a communication cluster. The communication cluster has a central control node, which may also be a cluster header (CH) terminal. The central control node has one of the following functions: creating a communication cluster; controlling joining and leaving of a cluster member; performing resource coordination, allocating a sidelink transmission resource to another terminal device in the communication cluster, and receiving sidelink feedback information from another terminal device; and performing resource coordination with another communication cluster. As shown in FIG. 4, terminal devices 410, 420, and 430 form a communication cluster, the terminal device 410 is a central control node of the communication cluster, the terminal devices 420 and 430 are cluster members of the communication cluster, the terminal device 410 may allocate sidelink transmission resources to the terminal devices 420 and 430.

Device-to-device communication is a sidelink (SL) transmission technology based on D2D. Different from a conventional cellular system in which communication data is received or transmitted via a network device, device-to-device communication has higher spectral efficiency and a lower transmission delay. For example, a vehicle-to-everything system may perform communication through device-to-device communication. Currently, two transmission modes are defined for device-to-device communication in the 3rd Generation Partnership Project (3GPP): mode 1 and mode 2.

Mode 1: A transmission resource of a terminal device is allocated by a network device, and the terminal device transmits data on a sidelink by using the resource allocated by the network device. The network device may allocate, to the terminal device, a resource for a single transmission, or may allocate, to the terminal device, a resource for semi-static transmission. For example, as shown in FIG. 1, a terminal device is located within network coverage, and a network device allocates, to the terminal device, a transmission resource used for sidelink transmission.

Mode 2: A terminal device selects a resource from a resource pool to perform data transmission. For example, in FIG. 3, the terminal device is located outside network coverage. In this case, the terminal device may autonomously select a transmission resource from a pre-configured resource pool to perform sidelink transmission. Alternatively, as shown in FIG. 1, the terminal device may autonomously select a transmission resource from a network-configured resource pool to perform sidelink transmission.

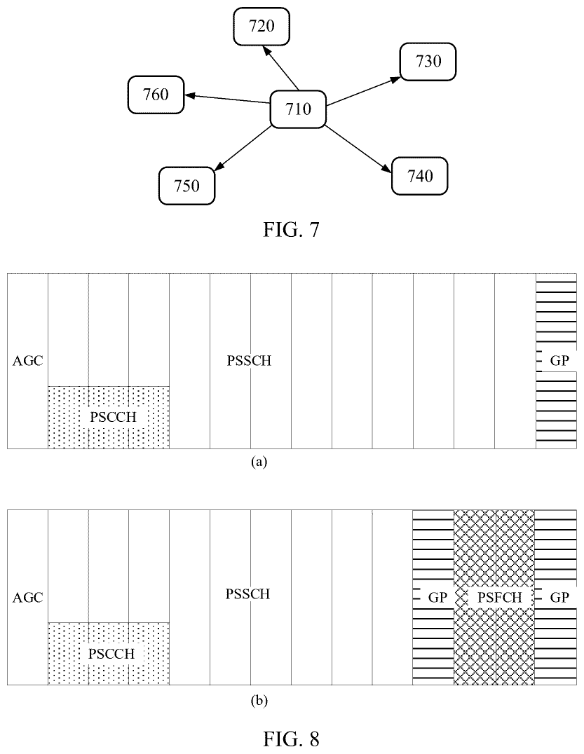

New radio vehicle to everything (NR-V2X) is a sidelink transmission technology used in vehicle wireless communication. In NR-V2X, transmission manners such as unicast, multicast, and broadcast are supported. For unicast transmission, there is only one receive terminal. As shown in FIG. 5, unicast transmission is carried out between a terminal device 510 and a terminal device 520. For multicast transmission, all terminal devices in a communication cluster are receive ends, or all terminal devices within a particular transmission distance are receive ends. As shown in FIG. 6, terminal devices 610, 620, 630, and 640 form a communication cluster, where the terminal device 610 transmits data, and the other terminal devices in the communication cluster are all receive end terminal devices. For broadcast transmission, a receive terminal is any terminal around a transmit end terminal device. As shown in FIG. 7, a terminal device 710 is a transmit end terminal device, and terminal devices 720 to 760 are all receive end terminal devices around the terminal device 710. The terminal device 710 may transmit data to the terminal devices 720 to 760.

A slot structure in NR-V2X may be shown in FIG. 8. Part (a) in FIG. 8 shows a slot structure in which a slot does not include a physical sidelink feedback channel (physical sidelink feedback channel, PSFCH). Part (b) in FIG. 8 shows a slot structure including a PSFCH.

As shown in FIG. 8, in NR-V2X, a physical sidelink control channel (PSCCH) starts from a 2^{nd} sidelink symbol of the slot in time domain and occupies two or three orthogonal frequency-division multiplexing (OFDM) symbols, and may occupy {10, 12 15, 20, 25} physical resource blocks (PRB) in frequency domain. To reduce complexity of blind detection performed by a UE on the PSCCH, only one PSCCH symbol quantity and one PRB quantity are allowed to be configured in one resource pool. In addition, because a sub-channel is a minimum granularity for allocation of a physical sidelink shared channel (PSSCH) resource in NR-V2X, a quantity of PRBs occupied by a PSCCH is less than or equal to a quantity of PRBs included in one sub-channel in a resource pool, thereby avoiding an additional limitation on selection or allocation of the PSSCH resource. As shown in part (a) in FIG. 8, a PSSCH also starts from the 2^{nd} sidelink symbol of the slot in time domain. The last time domain symbol in the slot is a guard period (GP) symbol, and the remaining symbols are mapped to the PSSCH. A 1^{st} sidelink symbol in the slot is a repetition of the 2^{nd} sidelink symbol. Usually, a receive end terminal device uses the 1^{st} sidelink symbol as an automatic gain control (AGC) symbol, and usually data on this symbol is not used for data demodulation. The PSSCH may occupy K sub-channels in frequency domain, and each sub-channel may include M consecutive PRBs, where K and M are integers.

As shown in part (b) in FIG. 8, when a slot includes a PSFCH channel, the second-to-last and the third-to-last symbols in the slot are used for transmission of the PSFCH channel, and a time domain symbol located before the PSFCH channel is used as a GP symbol.

In NR-V2X, the PSSCH is used to carry 2nd-stage sidelink control information (SCI) (for example, SCI 2-A or SCI 2-B, which is detailed in subsequent description) and data information. The 2nd-stage SCI uses a polar coding scheme and fixedly uses quadrature phase shift keying (QPSK) modulation. A data part of the PSSCH uses low-density parity-check (LDPC) code, and a maximum modulation order supported is 256 quadrature amplitude modulation (QAM).

In NR-V2X, the PSSCH supports a maximum of two streams for transmission. In addition, a unitary precoding matrix is used to map data in two layers to two antenna ports, and only one transport block (TB) can be transmitted in one PSSCH. However, different from a transmission mode for the data part of the PSSCH, when a dual-stream transmission mode is used for the PSSCH, modulation symbols of the 2nd-stage SCI on the two streams are completely the same, thereby ensuring receiving performance of the 2nd-stage SCI on a high-correlation channel.

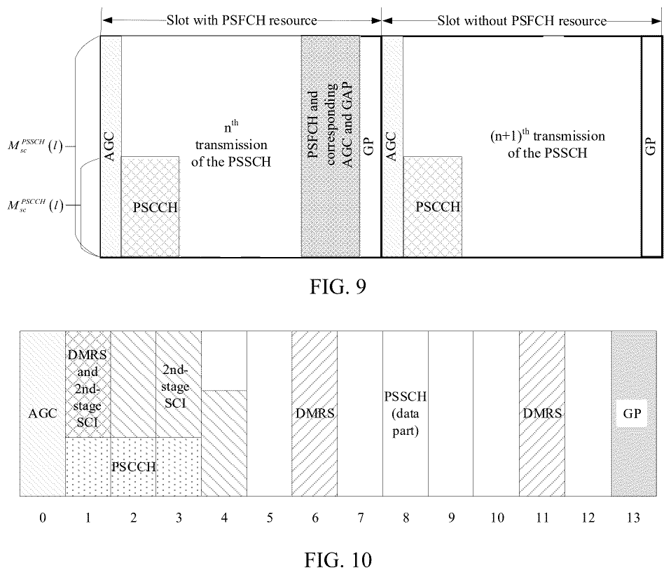

Because a maximum number of retransmissions of a PSSCH in NR-V2X is 32, if there are PSFCH resources in the resource pool and a configuration periodicity of the PSFCH resources is 2 or 4, available OFDM symbols in slot in which different transmissions of a PSSCH are performed may change, as shown in FIG. 9. If

$${N}_{symbol}^{PSSCH} ( {N}_{symbol}^{PSSCH}$$

represents a reference value of a quantity of symbols occupied by the PSSCH) is calculated based on a real quantity of OFDM symbols in one slot, values of

$${Q}_{SCI 2}^{′}$$

may vary due to different quantities of symbols available for transmissions of the PSSCH in one slot, and a change of

$${Q}_{SCI 2}^{′}$$

causes a change of a size of a TB carried by the PSSCH, as mentioned below. To ensure that a transport block size (transmission block size, TBS) remains unchanged during a plurality of PSSCH transmissions, the real quantity of PSFCH symbols is not used during calculation of

$${N}_{symbol}^{PSSCH} .$$

In addition, during calculation of

$${M}_{s c}^{SCI 2} ( l ) ,$$

a quantity of resource element (RE) occupied by a PSSCH demodulation reference signal (DMRS) and a quantity of REs occupied by a phase tracking reference signal (PT-RS) that may change during a retransmission process are also not considered. Herein, n and 1 in FIG. 9 are integers.

A code rate of the 2nd-stage SCI may be dynamically adjusted within a particular range. A specific code rate is indicated by 1st-stage SCI. Therefore, a receive end does not need to perform blind detection on the 2nd-stage SCI even when the code rate changes. Modulation symbols of the 2nd-stage SCI may be mapped, starting from a symbol in which a 1st PSSCH DMRS is located, based on a manner of mapping first in frequency domain and then in time domain. On OFDM symbols in which the DMRS is located, the 2nd-stage SCI may be mapped to an RE not occupied by the DMRS, as shown in FIG. 10.

A data part of a PSSCH in a resource pool may use a plurality of different modulation and coding scheme (MCS) tables, including a conventional 64QAM MCS table, a 256QAM MCS table, and a low spectral efficiency 64QAM MCS table. An MCS table specifically used in one transmission is indicated by an “MCS table indication” field in the 1st-stage SCI. To control a peak-to-average power ratio (peak-to-average power ratio, PAPR), the PSSCH needs to be transmitted using continuous PRBs. Because a sub-channel is a minimum frequency domain resource granularity of the PSSCH, this requires PSSCH to occupy continuous sub-channels.

A transport block size (TBS) determining mechanism for a physical downlink shared channel (PDSCH) and a physical uplink shared channel (PUSCH) in NR is inherited for a PSSCH, that is, a TBS is determined based on a reference value of a quantity of REs used for the PSSCH in a slot in which the PSSCH is located, so that an actual code rate is as close to a target code rate as possible. It should be noted that, to ensure that a quantity of REs used to determine a TBS remains unchanged in a PSSCH retransmission process, a reference value of the quantity of RES is used instead of using an actual quantity of REs, so that a determined TBS size keeps the same. To achieve this objective, in the TBS determining process, the reference value N_{RE} of the quantity of REs occupied by the PSSCH may be determined according to Formula (1) below:

$${N}_{R E} = {N}_{R E}^{′} \cdot {n}_{P R B} - {N}_{R E}^{SCI , 1} - {N}_{R E}^{SCI , 2} \qquad ( 1 )$$

Herein, n_{PRB} represents a quantity of PRBs occupied by the PSSCH,

$${N}_{R E}^{SCI , 1}$$

represents a quantity of REs (including REs occupied by a DMRS of the PSCCH) occupied by 1st-stage SCI,

$${N}_{R E}^{SCI , 2}$$

represents a quantity of REs occupied by 2nd-stage SCI, and

$${N}_{RE}^{′}$$

represents a quantity of reference REs available for the PSSCH in one PRB.

$${N}_{RE}^{′}$$

may be determined according to Formula (2) below:

$${N}_{R E}^{′} = {N}_{sc}^{R B} ( {N}_{symb}^{s h} - {N}_{symb}^{P S F C H} ) - {N}_{o h}^{P R B} - {N}_{RE}^{DMRS} \qquad ( 2 )$$

Herein,

$${N}_{s c}^{R B} = 12$$

represents a quantity of symbols that can be used for sidelink in one slot, excluding the last GP

$${N}_{s y m b}^{s h}$$

symbol and the 1^{st} symbol used for AGC.

$${N}_{s y m b}^{PSFCH} = 0 or 3 ,$$

where a specific value is indicated by “quantity of PSFCH symbols” field in the 1st-stage SCI, and is a reference value of the quantity of symbols occupied by the PSFCH. A value of

$${N}_{o h}^{P R B}$$

is configured by using an RRC layer parameter and is used to represent a reference value of a quantity of REs occupied by a PT-RS and a channel state information reference signal (CSI-RS).

$${N}_{R E}^{D M R S}$$

represents an average quantity of DMRS REs in one slot and is associated with a DMRS pattern allowed in a resource pool. A correspondence between the DMRS pattern and

$${N}_{R E}^{D M R S}$$

may be shown in Table 1 below.

TABLE 1
Correspondence between a DMRS pattern allowed in a
$resource pool and {N}_{R E}^{D M R S}$

| DMRS pattern | ${N}_{R E}^{D M R S}$ |
|---|---|
| {2} | 12 |
| {3} | 18 |
| {4} | 24 |
| {2.3} | 15 |
| {2.4} | 18 |
| {3.4} | 21 |
| (2, 3, 4} | 18 |

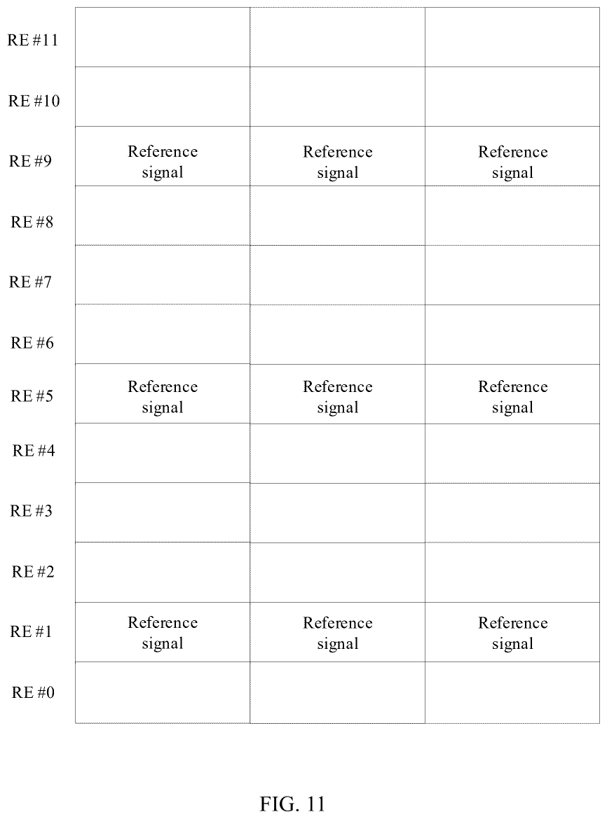

In NR-V2X, a DMRS pattern of the PSCCH is the same as an NR physical downlink control channel (PDCCH), that is, a DMRS exists on OFDM symbols of each PSCCH, and is located in REs {#1, #5, #9} of one PRB in frequency domain, as shown in FIG. 11. A DMRS sequence of the PSCCH is generated by using Formula (3) below.

$${r}_{l} ( m ) = \frac{1}{\sqrt{2}} ( 1 - 2 c ( m ) ) + j \frac{1}{\sqrt{2}} ( 1 - 2 c ( m + 1 ) ) \qquad ( 3 )$$

A pseudo-random sequence c(m) is initialized by

$${c}_{i n i t} = ( {2}^{17} ( {N}_{s y m b}^{slot} {n}_{s , f}^{μ} + l + 1 ) ( 2 {N}_{I D} + 1 ) + 2 {N}_{I D} ) mod {2}^{31} ,$$

l herein is an index of an OFDM symbol in which the DMRS is located in a slot,

$${n}_{s , f}^{μ}$$

is an index of a slot in which the DMRS is located in a system frame, and

$${N}_{symb}^{slot}$$

represents a quantity of OFDM symbols in one slot, N_{ID}∈{0,1, . . . , 65535}. In a resource pool, a specific value of N_{ID} is network-configured or pre-configured.

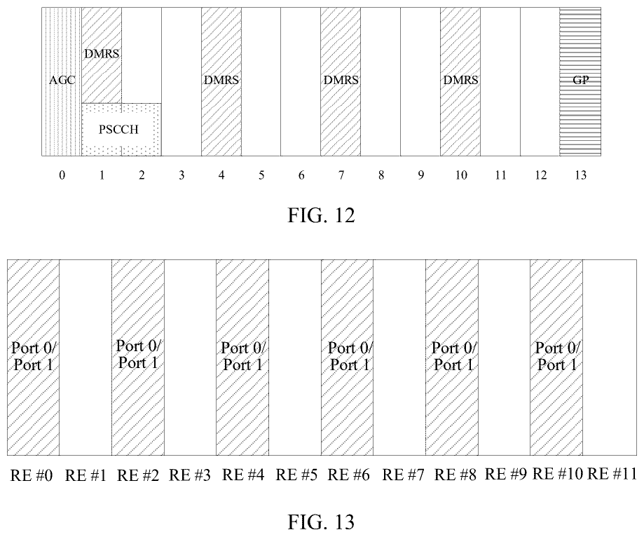

NR-V2X draws on NR Uu interface design and adopts a plurality of time-domain PSSCH DMRS patterns. In a resource pool, a quantity of DMRS patterns that can be used is associated with a quantity of PSSCH symbols in the resource pool. For a specific quantity of PSSCH symbols (including the 1st AGC symbol) and a specific quantity of PSCCH symbols, available DMRS patterns and a location of each DMRS symbol in a pattern are shown in Table 2 below. FIG. 12 is a schematic diagram of time domain locations of four DMRS symbols in a case of 13 PSSCH symbols.

TABLE 2
Quantities and locations of DMRS symbols for different
quantities of PSSCH and PSCCH symbols

| Quantity of | | | | | | |
|---|---|---|---|---|---|---|
| PSSCH | Locations of DMRS symbols (relative to a location of the 1^{st} AGC symbol) | | | | | |
| symbols | Quantity of PSCCH | | | Quantity of PSCCH | | |
| (including | symbols being 2 | | | symbols being 3 | | |
| the 1^{st} AGC | Quantity of DMRS symbols | | | Quantity of DMRS symbols | | |
| symbol) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

If a plurality of time-domain DMRS patterns are configured in a resource pool, a time-domain DMRS pattern to be used is selected by a transmit-end UE and indicated in 1st-stage SCI. In this design, a high-speed moving UE is allowed to select a high-density DMRS pattern, thereby ensuring accuracy of channel estimation; while a low-speed moving UE may use a low-density DMRS pattern, thereby improving spectral efficiency.

A manner of generating a PSSCH DMRS sequence is almost the same as a manner of generating a PSCCH DMRS sequence, and an only difference lies in that, in an initialization formula cᵢₙᵢₜ of a pseudo-random sequence c(m),

$${N}_{ID} = {\sum }_{i = 0}^{L - 1} {p}_{i} \cdot {2}^{L - 1 - i} ,$$

where pᵢ is an iₜₕ CRC value of a PSCCH that schedules a PSSCH, and L=24 is a quantity of bits of PSCCH CRC.

NR PDSCH and PUSCH support two frequency domain DMRS patterns: DMRS frequency domain type 1 and DMRS frequency domain type 2; and for each frequency domain type of the type 1 and the type 2, there are two different types: a single DMRS symbol and double DMRS symbols. Single-symbol DMRS frequency domain type 1 supports four DMRS ports, and single-symbol DMRS frequency domain type 2 supports six DMRS ports. In a case of double DMRS symbols, the quantity of supported ports is doubled. However, in NR-V2X, because a PSSCH may be required to support a maximum of only two DMRS ports, only single-symbol DMRS frequency domain type 1 is supported, as shown in FIG. 13.

To better support unicast communication, NR-V2X supports an SL CSI-RS. An SL CSI-RS is transmitted only when the following conditions are met:
(1) A UE transmits a corresponding PSSCH, that is, the UE cannot transmit an SL CSI-RS alone.
(2) Higher layer signaling activates reporting of sidelink CSI.
(3) When sidelink CSI reporting is activated by higher layer signaling, a corresponding bit in 2nd-stage SCI transmitted by the UE triggers the sidelink CSI reporting.

A maximum quantity of ports supported by an SL CSI-RS is 2. When two ports are supported, SL CSI-RSs of different ports are multiplexed in a code division manner on two adjacent REs of a same OFDM symbol, and a quantity of SL CSI-RSs of each port in one PRB is 1, that is, a density is 1. Therefore, in one PRB, the SL CSI-RS appears on a maximum of one OFDM symbol. A specific location of the OFDM symbol is determined by a transmit terminal. To avoid impact on resource mapping of a PSCCH and 2nd-stage SCI, the SL CSI-RS cannot be located on a same OFDM symbol as the PSCCH or the second stage SCI. An OFDM symbol in which a DMRS of a PSSCH is located has relatively high channel estimation accuracy, and SL CSI-RSs of two ports occupy two consecutive REs in frequency domain. Therefore, the SL CSI-RSs cannot be transmitted on a same OFDM symbol as the DMRS of the PSSCH. A location of an OFDM symbol in which an SL CSI-RS is located is indicated by an sl-CSI-RS-FirstSymbol parameter in PC5 RRC.

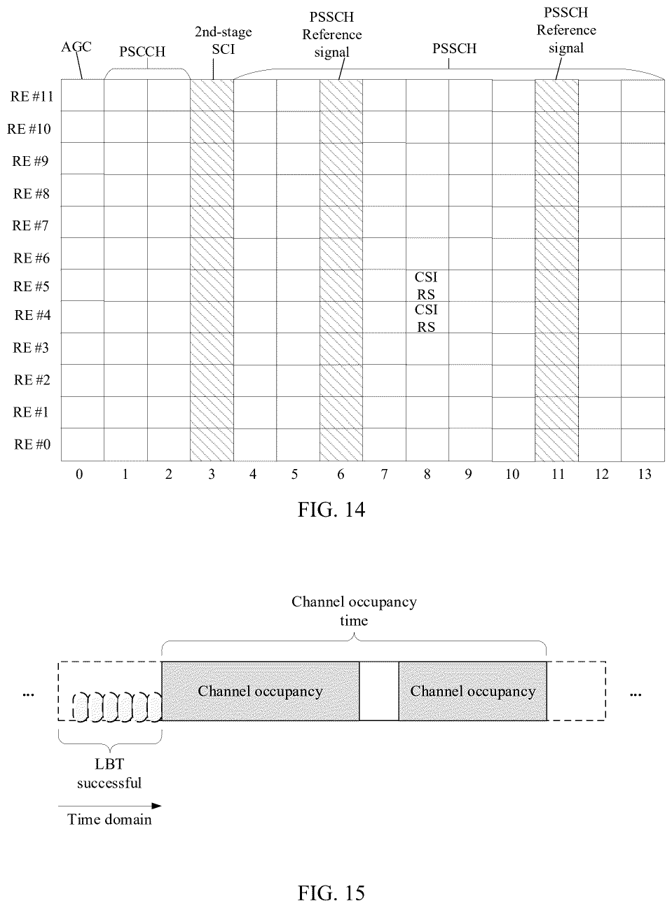

A location of the 1^{st} RE occupied by the SL CSI-RS in one PRB is indicated by an sl-CSI-RS-FreqAllocation parameter in PC5 RRC. For a single-port SL CSI-RS, the parameter is a bitmap with a length of 12, which corresponds to 12 REs in one PRB. For a two-port SL CSI-RS, the parameter is a bitmap with a length of 6; and in this case, the SL CSI-RS occupies two REs, that is, 2Θ(1) and 2Θ(1)+1, where ƒ(1) indicates an index of a bit with a value of 1 in the foregoing bitmap. A frequency domain location of the SL CSI-RS is also determined by the transmit terminal, but the determined frequency domain location of the SL CSI-RS cannot conflict with a PT-RS. FIG. 14 is a schematic diagram of a time-frequency location of an SL CSI-RS. In FIG. 14, a quantity of SL CSI-RS ports is 2, sl-CSI-RS-FirstSymbol is 8, and sl-CSI-RS-FreqAllocation is [b₅,b₄,b₃,b₂,b₁, b₀]=[0,0,0,1,0,0].

An NR system introduced in the 3GPP Release 15 (R15) standards is a communication technology used in existing and new licensed spectrums. An NR system may achieve seamless coverage, high spectral efficiency, high peak rates, and high reliability for cellular networks. In an LTE system, unlicensed spectrum (non-licensed spectrum) is used as a supplementary band to licensed spectrum for cellular networks. Similarly, an NR system may also use unlicensed spectrum as part of a 5G cellular network technology to provide a service for a user. In the 3GPP R16 standards, an NR system applied to unlicensed spectrum is discussed, which is referred to as NR-unlicensed (NR-U).

An NR-U system supports two networking modes: licensed spectrum assisted access and unlicensed spectrum independent access. The former requires a UE to access a network by using a licensed spectrum, and unlicensed spectrum is used as secondary carriers. The latter may be used for independent networking by using unlicensed spectrum, and a UE may directly access a network by using the unlicensed spectrum. A range of unlicensed spectrum used by an NR-U system introduced in 3GPP R16 is mainly used in 5 GHz and 6 GHz frequency bands, for example, 5925 MHz to 7125 MHz in the United States, or 5925 MHz to 6425 MHz in Europe. In the R16 standards, band 46 (5150 MHz to 5925 MHz) is newly defined and is used as unlicensed spectrum.

Unlicensed spectrum is a spectrum obtained by division by a country and a region and that can be used for communication of a radio device. The spectrum is generally considered as a shared spectrum. That is, a communication device can use the spectrum provided that a regulatory requirement set for the spectrum by a country or a region is met, without applying for a dedicated spectrum grant from a dedicated spectrum management authority of the country or the region. The use of unlicensed spectrum needs to meet requirements of specific laws and regulations of various countries and regions. For example, a communication device uses unlicensed spectrum according to a “listen before talk” (LBT) principle. Therefore, the NR technology needs to be correspondingly enhanced to meet regulatory requirements set for an unlicensed frequency band while efficiently providing services by using the unlicensed spectrum. In the 3GPP R16 standards, the NR-U technology is standardized in the following aspects: channel monitoring process; initial access process; control channel design; HARQ and scheduling; scheduling-free grant transmission; and the like.

To enable communication systems that perform wireless communication by using unlicensed spectrum to coexist on the spectrum, some countries or regions stipulate regulatory requirements that must be met for the use of the unlicensed spectrum. For example, according to regulations in the European region, when unlicensed spectrum is used for communication, a communication device complies with a “listen before talk” (LBT) principle, that is, before transmitting a signal through a channel on the unlicensed spectrum, the communication device needs to perform LBT, or channel monitoring. The communication device can transmit a signal by using the channel only when a channel monitoring result indicates that the channel is idle or the LBT succeeds. If a channel monitoring result of the communication device on the channel indicates that the channel is busy or the LBT fails, the communication device cannot transmit a signal through the channel. In addition, to ensure fairness in using a spectrum resource of shared spectrum, if the communication device performs LBT successfully in unlicensed spectrum, duration in which the communication device may perform communication transmission by using use the channel cannot exceed specific duration. In this mechanism, maximum duration available for communication after one time of successful LBT is restricted, so that different communication devices may access the shared channel, and different communication systems coexist friendly in the shared spectrum.

Channel monitoring is not a global regulation. Because channel monitoring can generate benefits of interference avoidance and friendly coexistence to communication transmission between communication systems on shared spectrum, in a design process of an NR system on unlicensed spectrum, channel monitoring is a feature that must be supported by a communication device in the system. From the perspective of network deployment for a system, channel monitoring includes two mechanisms: one is LBT for load based equipment (LBE), also referred to as dynamic channel monitoring or dynamic channel occupancy; and the other is LBT for frame based equipment (frame based equipment, FBE), also referred to as semi-persistent channel monitoring or semi-persistent channel occupancy.

Dynamic channel monitoring may also be considered as an LBE-based LBT mode. A channel monitoring principle of the dynamic channel monitoring is as follows: After a service arrives, the communication device performs LBT on a carrier in unlicensed spectrum, and starts to transmit a signal on the carrier when the LBT succeeds. LBT modes for dynamic channel monitoring may include Type 1 channel access mode and Type 2 channel access mode. The Type 1 channel access mode is random fallback multi-slot channel detection that is based on contention window size adjustment, and a corresponding channel access priority class (CAPC) p may be selected based on a priority of a service to be transmitted. The Type 2 channel access mode is a channel access mode based on a fixed-length listening slot, and the Type 2 channel access mode includes Type 2A channel access, Type 2B channel access, and Type 2C channel access. The Type 1 channel access mode is mainly used by a communication device to initiate channel occupancy, and the Type 2 channel access mode is mainly used by the communication device to share a channel occupancy. It should be noted that in a special case, when a base station initiates channel occupancy for transmission of an SS/PBCH block in a discovery reference signal (DRS) and a DRS window does not include unicast data transmission performed by a UE, the base station may use Type 2A channel access to initiate channel occupancy if a DRS window length does not exceed 1 ms and a duty cycle of transmission in the DRS window does not exceed 1/20.

FIG. 15 is an example diagram of a channel occupancy time obtained by a communication device after successful LBT on a channel in unlicensed spectrum and use of resources within the channel occupancy time for signal transmission.

A default channel access mode on the base station side is Type 1 channel access. A base station is used as an example. A channel access parameter corresponding to a channel access priority class p on the base station side is shown in Table 3 below. If a channel access process ends, the base station may use the channel to transmit a to-be-transmitted service. A maximum time length for which the base station can use the channel for transmission cannot not exceed T_{mcot, p}.

TABLE 3
Channel access parameters corresponding
to different channel priorities

| Channel | | | | | |
|---|---|---|---|---|---|
| access priority | | | | | Allowed CWₚ |
| class (p) | mₚ | CW_{min, p} | CW_{max, p} | T_{mcot, p} | value |
| 1 | 2 | 3 | 7 | 2 ms | {3, 7} |
| 2 | 2 | 7 | 15 | 4 ms | {7, 15} |
| 3 | 3 | 15 | 1023 | 6/10 | {15, 31, 63, 127, |
| | | | | ms | 255, 511, 1023} |
| 4 | 7 | 15 | 1023 | 6/10 | {15, 31, 63, 127, |
| | | | | ms | 255, 511, 1023} |

In Table 3, mₚ represents a quantity of fallback slots corresponding to a channel access priority class, CWₚ represents a size of a contention window corresponding to the channel access priority class, CW_{min, p} represents a minimum value of CWₚ corresponding to the channel access priority class, CW_{max, p} represents a maximum value of CWₚ corresponding to the channel access priority class, and T_{mcot, p} represents a maximum occupancy duration of a channel corresponding to the channel access priority class.

After a base station initiates a channel occupancy time (COT), in addition to using a resource in the COT for downlink transmission, the base station may further share the resource in the COT to a UE for uplink transmission. When the resource in the COT is shared to the UE for uplink transmission, a channel access mode that can be used by the UE is Type 2A channel access, Type 2B channel access, or Type 2C channel access, where Type 2A channel access, Type 2B channel access, and Type 2C channel access are all channel access modes based on a listening slot of a fixed length. Type 2 channel access uses channel detection based on a channel monitoring slot of a fixed length. Type 2 channel access may include the following types:

Type 2A channel access: A terminal device uses 25-μs single-slot channel detection. Specifically, in Type 2A channel access, the terminal device may perform channel monitoring for 25 μs before transmission starts, and perform data transmission after the channel monitoring succeeds.

Type 2B channel access: A terminal device uses 16-μs single-slot channel detection. Specifically, in Type 2B channel access, the terminal device may perform channel monitoring for 16 μs before transmission starts, and perform transmission after the channel monitoring succeeds. A gap between a start location of the current transmission and an end location of a previous transmission is 16 μs.

Type 2C channel access: A terminal device does not perform channel detection after a gap ends. Specifically, in Type 2C channel access, the terminal device may directly perform transmission, and a gap between a start location of the current transmission and an end location of a previous transmission is less than or equal to 16 μs. A length of the transmission does not exceed 584 μs.

In an NR-U system, when a UE is scheduled to perform transmission of a physical uplink shared channel (PUSCH) or physical uplink control channel (PUCCH), a base station may carry downlink control information (DCI) of an uplink grant (UL grant) or a downlink grant (DL grant) to indicate a channel access mode corresponding to the PUSCH or the PUCCH. Because some channel access modes need to meet a gap requirement of 16 μs or 25 μs, the UE may ensure a gap between two transmissions by transmitting a cyclic prefix extension (CPE). Correspondingly, the base station may indicate a CPE length of the 1^{st} symbol of uplink transmission of the UE.

In a specific indication, the base station may explicitly indicate, to the UE in a joint coding manner, a channel access parameter such as a CPE length, a channel access mode, or a channel access priority class. The following describes features of manners of indicating a channel access parameter introduced in different DCI formats.

Fallback uplink grant for scheduling PUSCH transmission (DCI format 0_0): a predefined set in a standard jointly indicating a channel access mode and a CPE length. The fallback uplink grant includes 2-bit LBT indication information, which is used to indicate, from a predefined set (jointly indicated by preset channel access modes and CPE lengths in the standard), a jointly encoded channel access mode and CPE length. The channel access mode and the CPE length are used for transmission of a PUSCH. If the channel access mode is Type 1 channel access, the UE autonomously selects a channel access priority class (CAPC) based on a service priority.

Fallback downlink grant for scheduling PDSCH transmission (DCI format 1_0): a predefined set in a standard jointly indicating a channel access mode and a CPE length, as shown in Table 4 below. The fallback downlink grant includes 2-bit LBT indication information, which is used to indicate a jointly encoded channel access mode and CPE length from a predefined set (jointly indicated by preset channel access modes and CPE lengths in the standard). The channel access mode and the CPE length are used for transmission of a PUCCH, where the PUCCH may carry ACK or NACK information corresponding to a PDSCH. If the channel access mode is Type 1 channel access, the UE determines that a channel access priority class CAPC used to transmit the PUCCH is 1.

Non-fallback uplink grant for PUSCH transmission (DCI format 0_1): A higher layer configures an LBT parameter indication set, where the LBT parameter indication set includes at least one jointly coded channel access mode, CPE length, and CAPC. The non-fallback uplink grant includes LBT indication information, and the LBT indication information is used to indicate, from the LBT parameter indication set, a jointly coded channel access mode, CPE length, and CAPC. The channel access mode, the CPE length, and the CAPC are used for transmission of a PUSCH. If the indicated channel access mode is Type 2 channel access, a CAPC indicated is a CAPC used when the base station obtains the COT. The LBT indication information includes a maximum of 6 bits.

Non-fallback downlink grant for PDSCH transmission (DCI format 1_1): A higher layer configures an LBT parameter indication set, where the LBT parameter indication set includes at least one jointly coded channel access mode and CPE length. The non-fallback downlink grant includes LBT indication information, and the LBT indication information is used to indicate, from the LBT parameter indication set, a jointly coded channel access mode and CPE length. The channel access mode and the CPE length are used for transmission of a PUCCH, where the PUCCH may carry ACK or NACK information corresponding to a PDSCH. If the channel access mode is Type 1 channel access, the UE determines that a channel access priority class CAPC used to transmit the PUCCH is 1. The LBT indication information includes a maximum of 4 bits.

TABLE 4
Joint indication set of a channel access mode and a CPE length

| LBT | | |
|---|---|---|
| indication | Channel access mode | CPE length |
| 0 | Type 2C channel access | C2*Symbol length - 16 μs - TA |
| 1 | Type 2A channel access | C3*Symbol length - 25 μs - TA |
| 2 | Type 2A channel access | C1*symbol length-25 μs |
| 3 | Type 1 channel access | 0 |

In Table 4, a value of C1 is specified in a protocol; and when a subcarrier spacing is 15 kHz or 30 kHz, C1=1, or when a subcarrier spacing is 60 kHz, C1=2. Values of C2 and C3 are configured by higher layer parameters; and when a subcarrier spacing is 15 kHz or 30 kHz, values of C2 and C3 range from 1 to 28, or when a subcarrier spacing is 60 kHz, C2 and C3 range from 2 to 28.

In addition to the foregoing explicit indications, the base station may further implicitly indicate a channel access mode in the COT. When a UL grant or a DL grant received by the UE and transmitted by the base station indicates that a channel access type corresponding to the PUSCH or the PUCCH is Type 1 channel access, and if the UE can determine that the PUSCH or the PUCCH belongs to a COT of the base station, for example, the UE receives the DCI format 2_0 transmitted by the base station, and determines, based on the DCI format 2_0, that the PUSCH or the PUCCH belongs to the COT of the base station, the UE may update the channel access type corresponding to the PUSCH or the PUCCH to Type 2A channel access, without using Type 1 channel for access any more.

In the conventional art, a sidelink is not used on an unlicensed frequency band, and the SL-U technology is currently under standardization discussion and formulation. In addition, in the current 3GPP sidelink version, existence of a terminal with a weak capability (for example, a terminal with a low capability (reduced capability, RedCap)) is not considered, and a case in which a terminal with a strong capability (or a terminal with a normal capability) communicates with and coexists with a terminal with a weak capability is not considered.

In an existing sidelink, it is assumed that bandwidths (usually maximum bandwidths) that can be supported by all terminals are the same. Therefore, only one sidelink bandwidth part (bandwidth part, BWP) can be configured for the sidelink. All the terminals perform sidelink communication in different resource pools within the BWP. One BWP has only one group of parameter sets and configuration parameters. Therefore, it is required that all terminals that use the BWP for sidelink communication must support a maximum bandwidth, for example, a bandwidth of 100 MHz.

It may be learned that, currently, a sidelink supports only one BWP, and communication between two terminals with different capabilities cannot be implemented. When a system includes both a terminal with a normal capability and a terminal with a weak capability, how to enable terminal devices with different capabilities to perform communication on a sidelink becomes a technical problem that needs to be urgently resolved.

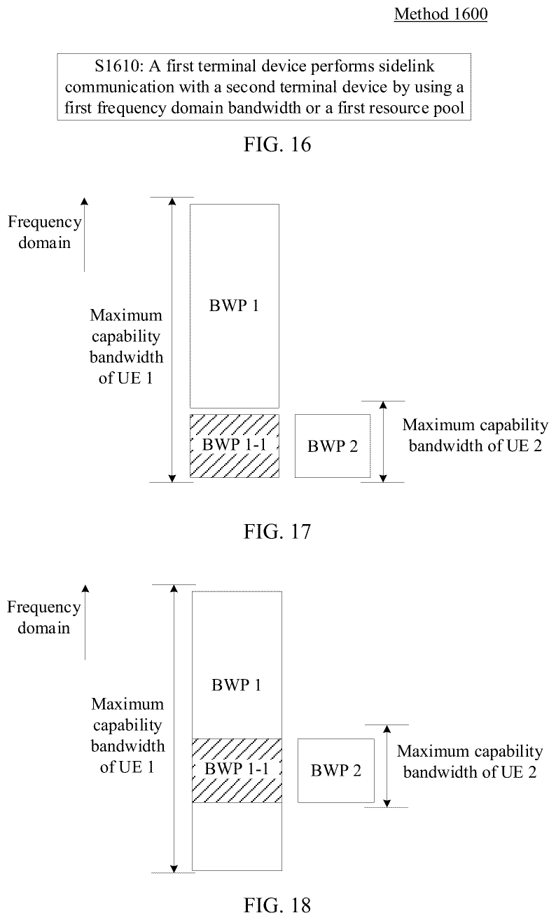

To resolve one or more of the foregoing technical problems, this application provides a communication method and a communication apparatus. The method in embodiments of this application is applicable to various frequency bands, such as a licensed frequency band, an intelligent transportation system (ITS) dedicated frequency band, an unlicensed frequency band, and the like. With reference to FIG. 16 to FIG. 21, the following describes embodiments of this application in detail by using examples.

FIG. 16 is a schematic flowchart of a communication method according to an embodiment of this application. The method 1600 shown in FIG. 16 may include step S1610. Details are as follows.

S1610: A first terminal device performs sidelink communication with a second terminal device by using a first frequency domain bandwidth or a first resource pool.

The first terminal device may be configured with the first frequency domain bandwidth and/or a second frequency domain bandwidth used for sidelink, or the first terminal device may be configured with the first resource pool and/or a second frequency domain bandwidth used for sidelink. In embodiments of this application, a frequency domain bandwidth may refer to a frequency domain resource, such as a carrier or frequency resource.

Optionally, the second frequency domain bandwidth may be less than or equal to a maximum bandwidth supported by the first terminal device. Optionally, the first frequency domain bandwidth may be network-configured or pre-configured. Optionally, the first resource pool may be network-configured or pre-configured.

Optionally, the second terminal device may be configured with a third frequency domain bandwidth used for sidelink. Optionally, the third frequency domain bandwidth may be less than or equal to a maximum bandwidth supported by the second terminal device.

Optionally, a maximum bandwidth supported by the first terminal device may be different from a maximum bandwidth supported by the second terminal device. Optionally, the maximum bandwidth supported by the first terminal device may be greater than the maximum bandwidth supported by the second terminal device. For example, the first terminal device may be a terminal with a normal capability, such as a mobile phone, and the second terminal device may be a terminal with a weak capability, such as RedCap UE.

Optionally, the first frequency domain bandwidth may be a default BWP or an initial BWP of the first terminal device, or the second frequency domain bandwidth may be a default BWP or an initial BWP of the first terminal device.

Optionally, the second frequency domain bandwidth may be greater than the third frequency domain bandwidth, and/or the second frequency domain bandwidth may be greater than the maximum bandwidth supported by the second terminal device.

In some embodiments, the first frequency domain bandwidth may be less than or equal to the third frequency domain bandwidth.

Optionally, at least one of the following parameters may be the same for the first frequency domain bandwidth and the third frequency domain bandwidth: a bandwidth size, a bandwidth location, or a configuration parameter.

Optionally, when the first frequency domain bandwidth is less than the third frequency domain bandwidth, a location (for example, a bandwidth location) of the first frequency domain bandwidth may overlap a location (for example, a bandwidth location) of the third frequency domain bandwidth, that is, the third frequency domain bandwidth includes the first frequency domain bandwidth. In this case, the configuration parameter of the first frequency domain bandwidth may be the same as the configuration parameter of the third frequency domain bandwidth.

For example, if the first frequency domain bandwidth is less than the third frequency domain bandwidth, the first frequency domain bandwidth may be a part of the third frequency domain bandwidth, that is, the third frequency domain bandwidth may include the first frequency domain bandwidth.

Optionally, when the first frequency domain bandwidth or a bandwidth of the first resource pool is equal to the third frequency domain bandwidth, the first frequency domain bandwidth may be equal to the third frequency domain bandwidth, that is, a bandwidth size, a bandwidth location, a configuration parameter, and the like may be the same for the first frequency domain bandwidth and the third frequency domain bandwidth.

For example, if the first frequency domain bandwidth is equal to the third frequency domain bandwidth, the first frequency domain bandwidth may completely overlap the third frequency domain bandwidth, and a configuration parameter of the first frequency domain bandwidth is the same as a configuration parameter of the third frequency domain bandwidth.

Optionally, a configuration of the first frequency domain bandwidth may be independent from a configuration of the second frequency domain bandwidth, that is, the first frequency domain bandwidth and the second frequency domain bandwidth are separately configured, and the configuration of the first frequency domain bandwidth and the configuration of the second frequency domain bandwidth do not affect each other. Optionally, a configuration parameter of the first frequency domain bandwidth may be the same as a configuration parameter of the second frequency domain bandwidth, or a configuration parameter of the first frequency domain bandwidth may be different from a configuration parameter of the second frequency domain bandwidth.

Optionally, a location relationship between the first frequency domain bandwidth and the second frequency domain bandwidth may meet at least one of the following: the second frequency domain bandwidth includes the first frequency domain bandwidth, the first frequency domain bandwidth partially overlaps the second frequency domain bandwidth in frequency domain, or the first frequency domain bandwidth does not overlap the second frequency domain bandwidth in frequency domain.

For example, as shown in FIG. 17, BWP 1 and BWP 1-1 do not overlap in frequency domain. As shown in FIG. 18, BWP 1 includes BWP 1-1. It may be learned from FIG. 17 and FIG. 18 that a bandwidth location and a bandwidth size may be the same for BWP 1-1 and BWP 2. UE 1 represents the first terminal device, UE 2 represents the second terminal device, BWP 1 represents the first frequency domain bandwidth, BWP 1-1 represents the second frequency domain bandwidth, and BWP 2 represents the third frequency domain bandwidth.

Optionally, the first terminal device may support only one frequency domain bandwidth at a same time point. For example, UE 1 can work only on BWP 1 or BWP 1-1 at a same time point. When UE 1 switches from BWP 1 to BWP 1-1, a BWP switching time t is required and is measured in milliseconds, where t is a positive number.

Alternatively, the first terminal device may support a plurality of frequency domain bandwidths at a same time point. For example, the UE I may communicate with a high-capability terminal on BWP 1, and the UE 1 may communicate with a weak-capability terminal (for example, UE2) on BWP 1-1.

In some embodiments, the bandwidth of the first resource pool may be less than or equal to the third frequency domain bandwidth.

Optionally, at least one of the following parameters may be the same for the bandwidth of the first resource pool and the third frequency domain bandwidth: a bandwidth size, a bandwidth location, or a configuration parameter.

Optionally, when the bandwidth of the first resource pool is less than the third frequency domain bandwidth, a location (for example, a bandwidth location) of the first resource pool may overlap a location (for example, a bandwidth location) of the third frequency domain bandwidth, that is, the third frequency domain bandwidth includes the first resource pool. In this case, a configuration parameter of the first resource pool may be the same as the configuration parameter of the third frequency domain bandwidth.

For example, if the bandwidth of the first resource pool is less than the third frequency domain bandwidth, the first resource pool may occupy a part of the bandwidth in the third frequency domain bandwidth, that is, the third frequency domain bandwidth includes the first resource pool.

Optionally, when the bandwidth of the first resource pool is equal to the third frequency domain bandwidth, a bandwidth size, a bandwidth location, and a configuration parameter may be the same for the first resource pool and the third frequency domain bandwidth.

For example, if the bandwidth of the first resource pool is equal to the third frequency domain bandwidth, the bandwidth of the first resource may completely overlap the third frequency domain bandwidth, and a configuration parameter of the first resource pool is the same as a configuration of the third frequency domain bandwidth.

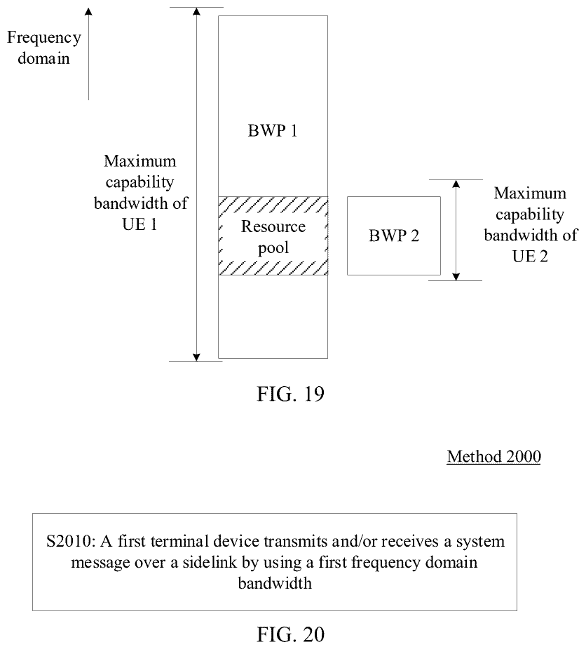

Optionally, the first resource pool may be configured on the second frequency domain bandwidth. Optionally, the bandwidth of the first resource pool may be less than or equal to the third frequency domain bandwidth. For example, as shown in FIG. 19, BWP 1 includes a resource pool, and a bandwidth of the resource pool is equal to a bandwidth of BWP 2.

Optionally, the first terminal device may perform sidelink communication with another terminal device with a strong capability on a bandwidth (or another resource) other than the first resource pool in the second frequency domain bandwidth. For example, the first terminal device may perform sidelink communication with a third terminal device by using a bandwidth other than the first resource pool in the second frequency domain bandwidth. Optionally, the third terminal device may be a strong-capability terminal.

Optionally, the first terminal device may transmit or receive a system message by using the first resource pool. Optionally, the system message may include at least one of the following: a sidelink master information block (MIB), a sidelink system information block (SIB), sidelink radio resource control (RRC) signaling, information related to a sidelink setup request, information related to a sidelink setup process, or sidelink synchronization information (for example, a sidelink synchronization signal block (S-SSB), where the S-SSB may include a sidelink primary synchronization signal (S-PSS), a sidelink secondary synchronization signal (S-SSS), and/or a physical sidelink broadcast channel (PSBCH)).

In embodiments of this application, a first frequency domain bandwidth or a bandwidth of a first resource pool configured by a first terminal device is less than or equal to a third frequency domain bandwidth configured by a second terminal device, and the first frequency domain bandwidth or the first resource pool facilitates implementing communication between different terminal devices on a sidelink.

FIG. 20 is a schematic flowchart of a communication method according to an embodiment of this application. A method 2000 shown in FIG. 20 may include step S2010. Details are as follows.

S2010: A first terminal device transmits and/or receives a system message over a sidelink by using a first frequency domain bandwidth.

The first terminal device may be configured with the first frequency domain bandwidth and a second frequency domain bandwidth used for sidelink. Optionally, the first frequency domain bandwidth may be less than or equal to the second frequency domain bandwidth. For example, the first frequency domain bandwidth may be a part of the second frequency domain bandwidth.

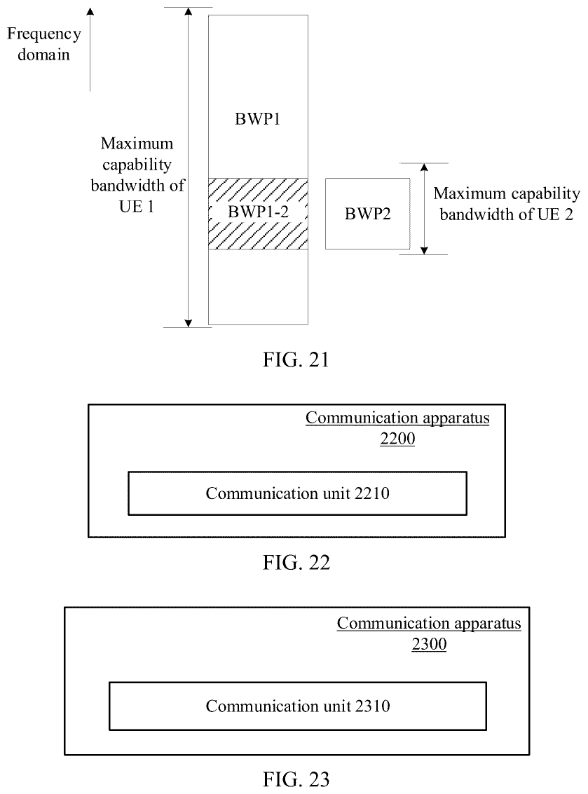

For example, as shown in FIG. 21, the BWP 1-2 may be a part of bandwidth belonging to BWP 1, and a bandwidth of the BWP 1-2 may be less than a bandwidth of BWP 1. UE 1 represents the first terminal device, BWP 1 represents the first frequency domain bandwidth, and BWP 1-2 represents the second frequency domain bandwidth.

Optionally, the first terminal device may use a configuration parameter of the second frequency domain bandwidth for the first frequency domain bandwidth. In other words, the second frequency domain bandwidth is not separately configured or does not appear alone.

Optionally, the first frequency domain bandwidth may be network-configured or pre-configured.

Optionally, the second frequency domain bandwidth may be a default BWP or an initial BWP of the first terminal device.

Optionally, the system message may include at least one of the following: a sidelink master information block (MIB), a sidelink system information block (SIB), sidelink radio resource control (RRC) signaling, information related to a sidelink setup request, information related to a sidelink setup process, or sidelink synchronization information (for example, a sidelink synchronization signal block (S-SSB). The S-SSB may include a sidelink primary synchronization signal (S-PSS), a sidelink secondary synchronization signal (S-SSS), and/or a physical sidelink broadcast channel (PSBCH).

Optionally, a location relationship between the first frequency domain bandwidth and the second frequency domain bandwidth may meet at least one of the following: the second frequency domain bandwidth includes the first frequency domain bandwidth, the first frequency domain bandwidth partially overlaps the second frequency domain bandwidth in frequency domain, or the first frequency domain bandwidth does not overlap the second frequency domain bandwidth in frequency domain.

In embodiments of this application, the first frequency domain bandwidth configured by the first terminal device is a part of the second frequency domain bandwidth, and the first terminal device transmits or receives the system message over a sidelink by using the first frequency domain bandwidth, without using an entire bandwidth of the second frequency domain bandwidth, so that resource utilization can be improved.

It should be noted that, in each frequency domain bandwidth or resource pool in the foregoing embodiment, both a resource mapping manner of contiguous resource blocks (RB) and a resource mapping manner of interlaced resource blocks (IRB) are supported.

The method embodiments of this application are described above in detail with reference to FIG. 1 to FIG. 21. Apparatus embodiments of this application are described below in detail with reference to FIG. 22 to FIG. 24. It should be understood that the descriptions of the method embodiments correspond to descriptions of the apparatus embodiments, and therefore, for parts that are not described in detail, reference may be made to the foregoing method embodiments.

FIG. 22 is a schematic structural diagram of a communication apparatus according to an embodiment of this application. As shown in FIG. 22, the apparatus 2200 includes a communication unit 2210.

The communication unit 2210 is configured to perform sidelink communication with a second terminal device by using a first frequency domain bandwidth or a first resource pool. The apparatus is configured with the first frequency domain bandwidth and/or a second frequency domain bandwidth used for sidelink, or configured with the first resource pool and/or a second frequency domain bandwidth used for sidelink. The second terminal device is configured with a third frequency domain bandwidth used for sidelink, and the first frequency domain bandwidth or a bandwidth of the first resource pool is less than or equal to the third frequency domain bandwidth.

Optionally, the first frequency domain bandwidth is network-configured or pre-configured.

Optionally, the first frequency domain bandwidth is a default bandwidth part BWP or an initial BWP of the apparatus, or the second frequency domain bandwidth is a default BWP or an initial BWP of the apparatus.

Optionally, a configuration of the first frequency domain bandwidth is independent from a configuration of the second frequency domain bandwidth.

Optionally, a configuration parameter of the first frequency domain bandwidth is the same as a configuration parameter of the second frequency domain bandwidth, or a configuration parameter of the first frequency domain bandwidth is different from a configuration parameter of the second frequency domain bandwidth.

Optionally, at least one of the following parameters is the same for the first frequency domain bandwidth and the third frequency domain bandwidth: a bandwidth size, a bandwidth location, or a configuration parameter.

Optionally, a location relationship between the first frequency domain bandwidth and the second frequency domain bandwidth meets at least one of the following:
the second frequency domain bandwidth includes the first frequency domain bandwidth, the first frequency domain bandwidth partially overlaps the second frequency domain bandwidth in frequency domain, or the first frequency domain bandwidth does not overlap the second frequency domain bandwidth in frequency domain.

Optionally, the apparatus supports only one frequency domain bandwidth at a same time point, or the apparatus supports a plurality of frequency domain bandwidths at a same time point.

Optionally, the first resource pool is network-configured or pre-configured.

Optionally, the first resource pool is configured on the second frequency domain bandwidth.

Optionally, the communication unit 2210 is further configured to perform sidelink communication with a third terminal device by using a bandwidth other than the first resource pool in the second frequency domain bandwidth.

Optionally, the communication unit 2210 is further configured to transmit or receive a system message by using the first resource pool.

Optionally, the system message includes at least one of the following: a sidelink system information block SIB, sidelink radio resource control RRC signaling, information related to a sidelink setup request, information related to a sidelink setup process, or sidelink synchronization information.

Optionally, a maximum bandwidth supported by the apparatus is different from a maximum bandwidth supported by the second terminal device.

Optionally, the maximum bandwidth supported by the apparatus is greater than the maximum bandwidth supported by the second terminal device.

Optionally, the second frequency domain bandwidth is greater than the third frequency domain bandwidth, and/or the second frequency domain bandwidth is greater than the maximum bandwidth supported by the second terminal device.

FIG. 23 is a schematic structural diagram of a communication apparatus according to an embodiment of this application. A communication apparatus 2300 in FIG. 23 includes a communication unit 2310.

The communication unit 2310 is configured to transmit and/or receive a system message over a sidelink by using a first frequency domain bandwidth. The apparatus is configured with the first frequency domain bandwidth and a second frequency domain bandwidth used for sidelink, and the first frequency domain bandwidth is a part of the second frequency domain bandwidth.

Optionally, the apparatus uses a configuration parameter of the second frequency domain bandwidth for the first frequency domain bandwidth.

Optionally, the first frequency domain bandwidth is network-configured or pre-configured.

Optionally, the second frequency domain bandwidth is a default BWP or an initial BWP of the apparatus.

Optionally, the system message includes at least one of the following:
a sidelink system information block SIB, sidelink radio resource control RRC signaling, information related to a sidelink setup request, information related to a sidelink setup process, or sidelink synchronization information.

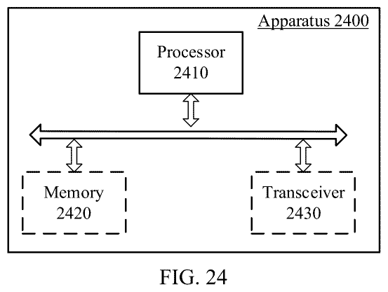

FIG. 24 is a schematic structural diagram of an apparatus according to an embodiment of this application. Dashed lines in FIG. 24 indicate that a unit or module is optional. The apparatus 2400 may be configured to implement the methods described in the foregoing method embodiments. The apparatus 2400 may be a chip or a communication apparatus.

The apparatus 2400 may include one or more processors 2410. The processor 2410 may support the apparatus 2400 in implementing the methods described in the foregoing method embodiments. The processor 2410 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 2400 may further include one or more memories 2420. The memory 2420 stores a program, where the program may be executed by the processor 2410, to cause the processor 2410 to execute the method described in the foregoing method embodiment. The memory 2420 may be separated from or integrated into the processor 2410.

The apparatus 2400 may further include a transceiver 2430. The processor 2410 may communicate with another device or chip through the transceiver 2430. For example, the processor 2410 may transmit data to and receive data from another device or chip through the transceiver 2430.

An embodiment of this application further provides a computer-readable storage medium for storing a program. The computer-readable storage medium may be applied to the communication apparatus provided in embodiments of this application, and the program causes a computer to perform the method executed by the communication apparatus in various embodiments of this application.

An embodiment of this application further provides a computer program product. The computer program product includes a program. The computer program product may be applied to the communication apparatus provided in embodiments of this application, and the program causes a computer to perform the method executed by the communication apparatus in various embodiments of this application.

An embodiment of this application further provides a computer program. The computer program may be applied to the communication apparatus provided in embodiments of this application, and the computer program causes a computer to perform the method executed by the communication apparatus in various embodiments of this application.

It should be understood that, in embodiments of this application, “B that is corresponding to A” means that B is associated with A, and B may be determined based on A. However, it should be further understood that, determining B based on A does not mean determining B based only on A, but instead, B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of the embodiments of this application.

In several embodiments provided in this application, it should be understood that the disclosed system, apparatus, and method may be implemented in another manner. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one location, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, through a coaxial cable, an optical fiber, or a digital subscriber line (DSL) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD), a semiconductor medium (for example, a solid state disk (SSD), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
performing, by a first terminal device, sidelink communication with a second terminal device by using a first frequency domain bandwidth or a first resource pool,
wherein the first terminal device is configured with the first frequency domain bandwidth and/or a second frequency domain bandwidth used for sidelink, or configured with the first resource pool and/or a second frequency domain bandwidth used for sidelink, the second terminal device is configured with a third frequency domain bandwidth used for sidelink, and the first frequency domain bandwidth or a bandwidth of the first resource pool is less than or equal to the third frequency domain bandwidth.

2. The method according to claim 1, wherein the first frequency domain bandwidth is network-configured or pre-configured.

3. The method according to claim 1, wherein the first frequency domain bandwidth is a default bandwidth part BWP or an initial BWP of the first terminal device, or the second frequency domain bandwidth is a default BWP or an initial BWP of the first terminal device.

4. The method according to claim 1, wherein a configuration of the first frequency domain bandwidth is independent from a configuration of the second frequency domain bandwidth.

5. The method according to claim 4, wherein a configuration parameter of the first frequency domain bandwidth is the same as a configuration parameter of the second frequency domain bandwidth, or a configuration parameter of the first frequency domain bandwidth is different from a configuration parameter of the second frequency domain bandwidth.

6. The method according to claim 1, wherein at least one of the following parameters is the same for the first frequency domain bandwidth and the third frequency domain bandwidth: a bandwidth size, a bandwidth location, or a configuration parameter.

7. The method according to claim 1, wherein a location relationship between the first frequency domain bandwidth and the second frequency domain bandwidth meets at least one of the following:
the second frequency domain bandwidth comprises the first frequency domain bandwidth, the first frequency domain bandwidth partially overlaps the second frequency domain bandwidth in frequency domain, or the first frequency domain bandwidth does not overlap the second frequency domain bandwidth in frequency domain.

8. The method according to claim 1, wherein the first terminal device supports only one frequency domain bandwidth at a same time point, or the first terminal device support a plurality of frequency domain bandwidths at a same time point.

9. The method according to claim 1, wherein the first resource pool is network-configured or pre-configured.

10. The method according to claim 1, wherein the first resource pool is configured on the second frequency domain bandwidth.

11. The method according to claim 10, wherein the method further comprises:
performing, by the first terminal device, sidelink communication with a third terminal device by using a bandwidth other than the first resource pool in the second frequency domain bandwidth.

12. The method according to claim 1, wherein the method further comprises:
transmitting or receiving, by the first terminal device, a system message by using the first resource pool.

13. The method according to claim 12, wherein the system message comprises at least one of the following:
a sidelink system information block SIB, sidelink radio resource control RRC signaling, information related to a sidelink setup request, information related to a sidelink setup process, or sidelink synchronization information.

14. The method according to claim 1, wherein a maximum bandwidth supported by the first terminal device is different from a maximum bandwidth supported by the second terminal device.

15. The method according to claim 14, wherein the maximum bandwidth supported by the first terminal device is greater than the maximum bandwidth supported by the second terminal device.

16. The method according to claim 1, wherein the second frequency domain bandwidth is greater than the third frequency domain bandwidth, and/or the second frequency domain bandwidth is greater than the maximum bandwidth supported by the second terminal device.

17. A first terminal device, comprising a memory and a processor, wherein the memory is configured to store a computer program, and the processor is configured to execute the computer program stored in the memory to cause the first terminal device to perform an operation of:
performing sidelink communication with a second terminal device by using a first frequency domain bandwidth or a first resource pool,
wherein the first terminal device is configured with the first frequency domain bandwidth and/or a second frequency domain bandwidth used for sidelink, or configured with the first resource pool and/or a second frequency domain bandwidth used for sidelink, the second terminal device is configured with a third frequency domain bandwidth used for sidelink, and the first frequency domain bandwidth or a bandwidth of the first resource pool is less than or equal to the third frequency domain bandwidth.

18. The first terminal device according to claim 17, wherein the first frequency domain bandwidth is network-configured or pre-configured.

19. The first terminal device according to claim 17, wherein the first frequency domain bandwidth is a default bandwidth part BWP or an initial BWP of the first terminal device, or the second frequency domain bandwidth is a default BWP or an initial BWP of the first terminal device.

20. A second terminal device, comprising a memory and a processor, wherein the memory is configured to store a computer program, and the processor is configured to execute the computer program stored in the memory to cause the second terminal device to perform an operation of:
transmitting and/or receiving a system message over a sidelink by using a first frequency domain bandwidth,
wherein the second terminal device is configured with the first frequency domain bandwidth and a second frequency domain bandwidth used for sidelink, and the first frequency domain bandwidth is a part of the second frequency domain bandwidth.
